(19) United States
(12) Patent Application Publication
(10) Pub. No.: US 2016/0014695 A1
(43) Pub. Date: Jan. 14, 2016

(54) DRX POWER USAGE BY DYNAMICALLY ADJUSTING A WARMUP PERIOD

(71) Applicant: QUALCOMM Incorporated, San Diego, CA (US)

(72) Inventors: Navid Ehsan, San Diego, CA (US); Raghu Narayan Challa, San Diego, CA (US); Chengjin Zhang, San Diego, CA (US)

(21) Appl. No.: 14/329,731

(22) Filed: Jul. 11, 2014

(51) Int. Cl. H04W 52/02; H04L 5/14

(52) U.S. Cl. CPC H04W 52/0235; H04L 5/14

(57) ABSTRACT

Methods, systems, and devices are described for improving discontinuous reception (DRX) power usage by dynamically updating (e.g., adjusting) a warmup period. A user equipment (UE) communicating with a wireless network may operate in DRX mode by periodically powering down radio components. For example, during a first DRX On Duration, the UE may estimate the variance in channel conditions. The UE may then update the baseband convergence portion of the warmup time prior to the upcoming DRX On Duration. The UE may reduce the baseband convergence period or increase the baseband convergence period based on a function of the channel variance. The UE may also maintain a table relating a set of channel variance values with a set of baseband convergence periods, and update the baseband convergence period based on the table.

### FIELD OF DISCLOSURE

The following relates generally to wireless communication, and more specifically to improving discontinuous reception (DRX) power usage by dynamically adjusting a warmup period.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, e.g., a Long Term Evolution (LTE) system.

Generally, a wireless multiple-access communications system may include a number of base stations, each simultaneously supporting communication for multiple mobile devices or other user equipment (UE) devices. Base stations may communicate with UEs on downstream and upstream links. Each base station has a coverage range, which may be referred to as the coverage area of the cell.

A UE in the coverage area of a cell may not continuously receive or transmit data. In some cases the UE may utilize a discontinuous reception (DRX) cycle during which the UE periodically turns some radio components off to conserve power and then reactivates the components for an On Duration to monitor for an indication that data may be available for reception. The UE may activate one or more radio components prior to the On Duration to warm up radio components and estimate channel parameters. If channel conditions have changed substantially from one On Duration to the next, it may take longer to generate an acceptably accurate estimate of current channel parameters. If channel conditions are substantially the same, convergence to an acceptable estimate may occur more quickly. Using a static warmup period in all cases may result in inefficient power usage during DRX operation.

### SUMMARY

The described features generally relate to one or more improved systems, methods, and/or apparatuses for improving discontinuous reception (DRX) power usage by dynamically adjusting a warmup period. A user equipment (UE) communicating with a wireless network may operate in DRX mode by periodically powering down radio components. Between two DRX periods or during an On Duration of a first DRX period, for example, the UE may estimate the variance in channel conditions. The UE may then update the baseband convergence portion of the warmup time prior to the upcoming DRX On Duration. The UE may reduce the baseband convergence period or increase the baseband convergence period based on a function of the channel variance. The UE may maintain a table relating a set of channel variance values with a set of baseband convergence periods, and update the baseband convergence period based on the table.

A method of improving DRX power usage by dynamically adjusting a warmup period is described, the method comprising communicating over a wireless channel in a DRX mode for a time period comprising a first on duration of a first DRX cycle and a second on duration of a second DRX cycle, estimating a channel variance for the wireless channel based on a set of parameters comprising at least one parameter measured during the first DRX cycle, and updating a baseband convergence period for the second on duration of the second DRX cycle based on the estimated channel variance.

An apparatus for improving DRX power usage by dynamically adjusting a warmup period is described, the apparatus comprising means for communicating over a wireless channel in a DRX mode for a time period comprising a first on duration of a first DRX cycle and a second on duration of a second DRX cycle, means for estimating a channel variance for the wireless channel based on a set of parameters comprising at least one parameter measured during the first DRX cycle, and means for updating a baseband convergence period for the second on duration of the second DRX cycle based on the estimated channel variance.

An apparatus for improving DRX power usage by dynamically adjusting a warmup period is described, the apparatus comprising a processor, memory in electronic communication with the processor, and instructions stored in the memory, the instructions being executable by the processor to communicate over a wireless channel in a DRX mode for a time period comprising a first on duration of a first DRX cycle and a second on duration of a second DRX cycle, estimate a channel variance for the wireless channel based on a set of parameters comprising at least one parameter measured during the first DRX cycle, and update a baseband convergence period for the second on duration of the second DRX cycle based on the estimated channel variance.

A non-transitory computer-readable medium storing code for improving DRX power usage by dynamically adjusting a warmup period is also described, the code comprising instructions executable by a processor to communicate over a wireless channel in a DRX mode for a time period comprising a first on duration of a first DRX cycle and a second on duration of a second DRX cycle, estimate a channel variance for the wireless channel based on a set of parameters comprising at least one parameter measured during the first DRX cycle, and update a baseband convergence period for the second on duration of the second DRX cycle based on the estimated channel variance.

In some examples of the method, apparatuses, and/or non-transitory computer-readable medium described above the baseband convergence period includes at least one of a time period for automatic gain control, a time period for frequency tracking loop convergence, or a time period for time tracking loop convergence. In some examples the set of parameters includes at least one of a Doppler measurement, an acceleration measurement, a channel correlation measurement, a signal-to-noise ratio (SNR), or a DRX gap length.

In some examples of the method, apparatuses, and/or non-transitory computer-readable medium described above the estimated channel variance does not satisfy a channel variance threshold, and updating the baseband convergence period includes reducing the baseband convergence period based on a function relating the estimated channel variance to a time for a baseband convergence period. In some examples the estimated channel variance satisfies a channel variance threshold, and updating the baseband convergence period includes increasing the baseband convergence period based on a function relating the estimated channel variance to a time for a baseband convergence period. In some cases, updating the baseband convergence period includes reducing or increasing the baseband convergence period based on a function relating the estimated channel variance to a time for a baseband convergence period.

Some examples of the method, apparatuses, and/or non-transitory computer-readable medium described above may include maintaining a table relating a set of channel variance values with a set of baseband convergence periods, and updating the baseband convergence period includes updating the baseband convergence period based on a lookup of the estimated channel variance in the table. Some examples may include activating a radio at a warmup time prior to the second on duration of the second DRX cycle, wherein the warmup time is based on the updated baseband convergence period. In some examples the warmup time is further based on a time period for generating a channel quality indicator (CQI) report.

In some examples of the method, apparatuses, and/or non-transitory computer-readable medium described above the warmup time is further based on a duplexing configuration of the wireless channel, the duplexing configuration comprising a frequency division duplex (FDD) configuration or a time division duplex (TDD) configuration.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with various aspects of the present disclosure.

FIG. 2 illustrates an example of a wireless communication system for improving DRX power usage by dynamically adjusting a warmup period in accordance with various aspects of the present disclosure.

FIG. 3A shows a diagram of an example DRX operation that includes dynamically adjusting the warmup period in accordance with various aspects of the present disclosure.

FIG. 3B shows a diagram of an example DRX operation that includes dynamically adjusting the warmup period in accordance with various aspects of the present disclosure.

FIG. 3C shows a diagram of an example DRX operation that includes dynamically adjusting the warmup period in accordance with various aspects of the present disclosure.

FIG. 4 shows a block diagram of a device for improving DRX power usage by dynamically adjusting a warmup period in accordance with various aspects of the present disclosure.

FIG. 5 shows a block diagram of a device for improving DRX power usage by dynamically adjusting a warmup period in accordance with various aspects of the present disclosure.

FIG. 6 shows a block diagram of a device for improving DRX power usage by dynamically adjusting a warmup period in accordance with various aspects of the present disclosure.

FIG. 7 illustrates a block diagram of a system for improving DRX power usage by dynamically adjusting a warmup period in accordance with various aspects of the present disclosure.

FIG. 8 shows a flowchart illustrating a method for improving DRX power usage by dynamically adjusting a warmup period in accordance with various aspects of the present disclosure.

FIG. 9 shows a flowchart illustrating a method for improving DRX power usage by dynamically adjusting a warmup period in accordance with various aspects of the present disclosure.

FIG. 10 shows a flowchart illustrating a method for improving DRX power usage by dynamically adjusting a warmup period in accordance with various aspects of the present disclosure.

FIG. 11 shows a flowchart illustrating a method for improving DRX power usage by dynamically adjusting a warmup period in accordance with various embodiment.

FIG. 12 shows a flowchart illustrating a method for improving DRX power usage by dynamically adjusting a warmup period in accordance with various aspects of the present disclosure.

### DETAILED DESCRIPTION

The described features generally relate to one or more improved systems, methods, and/or apparatuses for improving discontinuous reception (DRX) power usage by dynamically adjusting a warmup period. A user equipment (UE) communicating with a wireless network may operate in DRX mode by periodically powering down radio components. Between two DRX periods or during an On Duration of a first DRX period, for example, the UE may estimate the variance in channel conditions. The UE may then update the baseband convergence portion of the warmup time prior to the upcoming DRX On Duration. The UE may reduce the baseband convergence period or increase the baseband convergence period based on a function of the channel variance. The UE may maintain a table relating a set of channel variance values with a set of baseband convergence periods, and update the baseband convergence period based on the table.

Thus, according to aspects of the present disclosure, a UE may improve energy efficiency during DRX operation by dynamically adjusting the warmup time prior to each DRX On Duration. Specifically, reducing warmup time when channel conditions are changing slowly (e.g., when they have remained substantially unchanged) may reduce the period that a UE operates energy consuming radio components.

The following description provides examples, and is not limiting of the scope, applicability, or configuration set forth in the claims. Changes may be made in the function and arrangement of elements discussed without departing from the scope of the disclosure. Various aspects of the present disclosure may omit, substitute, or add various procedures or components as appropriate. For instance, the methods described may be performed in an order different from that described, and various steps may be added, omitted, or combined. Also, features described with respect to certain embodiments may be combined in other embodiments.

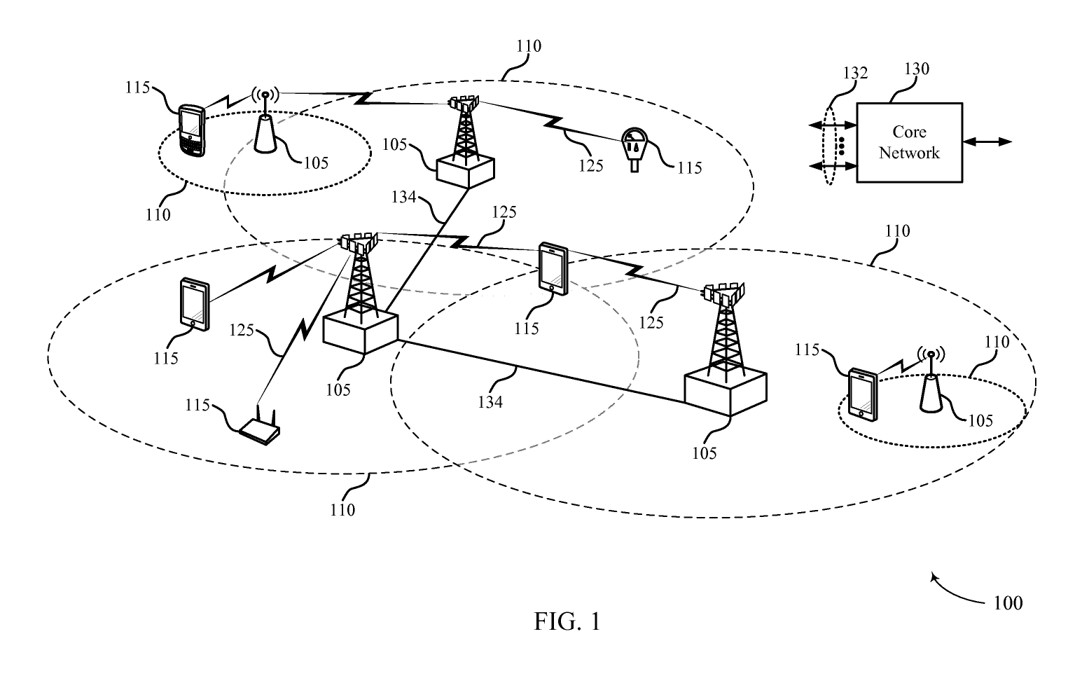

FIG. 1 illustrates an example of a wireless communications system 100 in accordance with various aspects of the present disclosure. The system 100 includes base stations 105, communication devices, also known as a user equipment UE 115, and a core network 130. The base stations 105 may communicate with the UEs 115 under the control of a base station controller (not shown), which may be part of the core network 130 or the base stations 105 in various aspects of the present disclosure. Base stations 105 may communicate control information and/or user data with the core network 130 through backhaul links 132. In embodiments, the base stations 105 may communicate, either directly or indirectly, with each other over backhaul links 134, which may be wired or wireless communication links The system 100 may support operation on multiple carriers (waveform signals of different frequencies). Wireless communication links 125 may be modulated according to various radio technologies. Each modulated signal may carry control information (e.g., reference signals, control channels, etc.), overhead information, data, etc.

The base stations 105 may wirelessly communicate with the UEs 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, evolved node B (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In embodiments, the system 100 is an LTE/LTE-A network. In LTE/LTE-A networks, the terms evolved Node B (eNB) and UE may be generally used to describe the base stations 105 and devices 115, respectively. The system 100 may be a Heterogeneous Long Term Evolution (LTE)/LTE-A network in which different types of base stations provide coverage for various geographical regions. For example, each eNB 105 may provide communication coverage for a macro cell, a small cell, and/or other types of cell. The term “cell” is a 3GPP term that can be used to describe a base station, a carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station that may operate in the same or different (e.g., licensed, unlicensed, etc.) frequency bands as macro cells. Small cells include pico cells, femto cells, and micro cells. A pico cell would generally cover a relatively smaller geographic area and may allow unrestricted access by UEs with service subscriptions with the network provider. A femto cell would also generally cover a relatively small geographic area (e.g., a home) and may provide restricted access by UEs having an association with the femto cell (e.g., UEs in a closed subscriber group (CSG), UEs for users in the home, and the like).

The core network 130 may communicate with the base stations 105 via a backhaul 132 (e.g., 51, etc.). The base stations 105 may also communicate with one another, e.g., directly or indirectly via backhaul links 134 (e.g., X2, etc.) and/or via backhaul links 132 (e.g., through core network 130). The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in system 100 may include uplink (UL) transmissions from a UE 115 to a base station 105, and/or downlink (DL) transmissions, from a base station 105 to a UE 115 over DL carriers. The downlink transmissions may also be called forward link transmissions while the uplink transmissions may also be called reverse link transmissions.

In some cases, a UE 115 may monitor a wireless link 125 continuously for an indication that the UE 115 may receive data. In other cases, for example while using low data rate or bursty applications, discontinuous reception (DRX) may be used as a power saving mechanism that allows the UE 115 to save power by turning off radio components between time periods used for transmission or reception of data. The DRX mechanism provides specific subframes when UE 115 is scheduled to be awake and decode the control channel and when the base station 105 can transmit any pending data. The amount of time a UE 115 can stay in the “sleep state” may depend on several factors. Some of the factors are controlled by the base station 105. For example, the base station 105 may configure the UE 115 with a DRX cycle that determines the periodicity for waking up to possibly receive data and the number of subframes the UE 115 must stay awake before going to sleep, (e.g., the “On Duration”).

A DRX cycle may include an On Duration when the UE 115 may monitor for control information (e.g., on a physical downlink control channel (PDCCH)) and a “DRX period” or “Opportunity for DRX” or “DRX sleep period” when the UE115 may power down one or more radio components. In some cases, a UE 115 may be configured with a short DRX cycle and a long DRX cycle. In some cases, a UE 115 may enter a long DRX cycle if it is inactive for one or more short DRX cycles. The transition between the short DRX cycle, the long DRX cycle and continuous reception may be controlled by an internal timer or by messaging from base station 105.

Prior to each On Duration, a UE 115 may initiate one or more radio components and/or estimate channel parameters during a warmup period. This warmup period is to be long enough that the radio components can converge to provide accurate demodulation and channel estimation in a wide range of channel conditions that may be experienced by the UE 115. However, a longer warmup period requires the UE 115 to initiate the radio components at an earlier time relative to the On Duration, and therefore consumes more power.

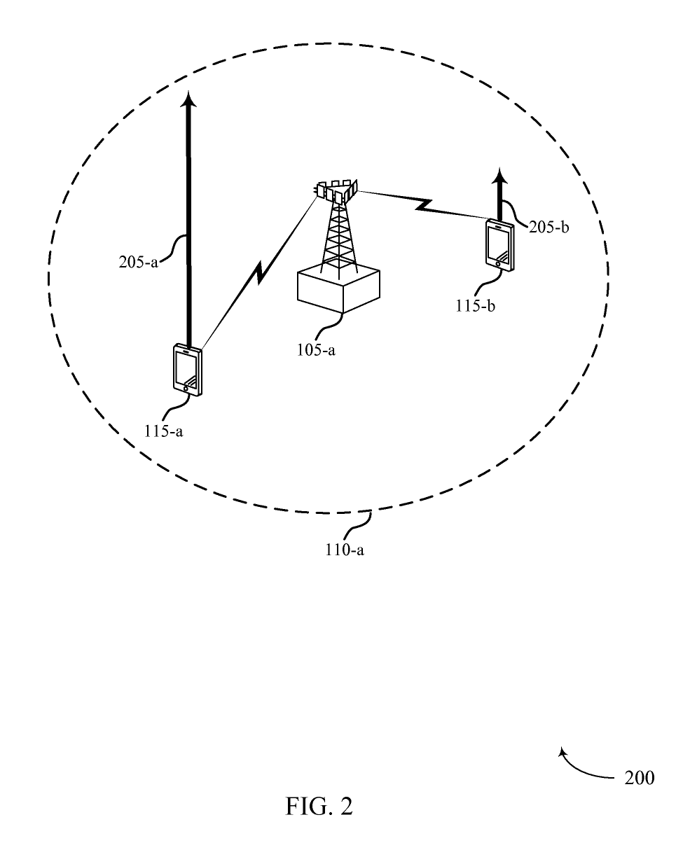

FIG. 2 illustrates an example of a wireless communication system 200 for dynamically adjusting a warmup period in accordance with various aspects of the present disclosure. System 200 may include a base station 105-a and UEs 115-a and 115-b, which may be examples of base stations 105 and UEs 115 described with reference to FIG. 1. UEs 115-a and 115-b may be located at different positions within the coverage area 110-a, and may have different velocity vectors 205-a and 205-b. System 200 depicts an example wherein the velocity vector 205-a for UE 115-a is greater than velocity vector 205-b of UE 115-b. UEs 115-a and 115-b may each communicate with base station 105-a and may both be configured in a DRX mode of operation. Based on the velocity vector and other factors (e.g., location in coverage area, surrounding topology, etc.), the channel conditions for UE 115-a may undergo a greater change from one DRX cycle to a subsequent DRX cycle than the channel conditions for UE 115-b.

The UEs 115 of systems 100 and/or 200, such as UEs 115-a and 115-b, may be configured to improve DRX power usage by dynamically adjusting a warmup period. For example, a UE 115 may receive downlink control information (DCI) (e.g., scheduling messages, etc.) on PDCCH. While monitoring PDCCH for a scheduling message, the UE 115 may initiate a “DRX Inactivity Timer.” If a scheduling message is successfully received, the UE 115 may prepare to receive data and the DRX Inactivity Timer may be reset. When the DRX Inactivity Timer expires without receiving a scheduling message, the UE 115 may move into a short DRX cycle and may start a “DRX Short Cycle Timer.” When the DRX Short Cycle Timer expires, the UE 115 may resume a long DRX cycle.

The UEs 115 may dynamically adjust the warmup period based on an estimated channel variance from a first DRX cycle to a subsequent DRX cycle. The UEs 115 may estimate the channel variance based on parameters related to measured channel conditions, other parameters measured by the UE, or UE timing parameters (e.g., DRX cycle configuration, etc.). For example, the set of parameters may include a Doppler measurement or other estimate of UE velocity, an acceleration measurement, a channel correlation measurement, a signal-to-noise ratio (SNR), DRX gap length, or other parameters. A warmup period may include several sub-periods, such as an radio frequency (RF) warmup period, a baseband convergence period, and/or a period for generating a CQI report. The UEs 115 may adjust the warmup period by increasing or reducing the baseband convergence period of the warmup period for the subsequent DRX cycle based on the estimated channel variance.

For example, UE 115-a may increase or reduce the baseband convergence period based on a function of velocity vector 205-a. For example, the estimated channel variance (which may be a function of velocity vector 205-a) for UE 115-a may be greater than a threshold and UE 115-a may increase the baseband convergence period. In some cases, increasing the baseband convergence period may include selecting a default convergence period, which may be a maximum convergence period. However, based on the shorter velocity vector 205-b, the estimated channel variance for UE 115-b may be less than the threshold and UE 115-b may decrease the baseband convergence period. That is, UE 115-b may achieve an acceptable level of convergence in a shorter period of time because the channel conditions are not changing as quickly.

In some examples, a UE 115 may maintain a table relating a set of channel variance values with a set of baseband convergence periods and updating the baseband convergence period may be based on a lookup of the estimated channel variance in the table. In other examples, the baseband convergence period may be based on a continuously varying function of the estimated channel variance or channel variance parameters.

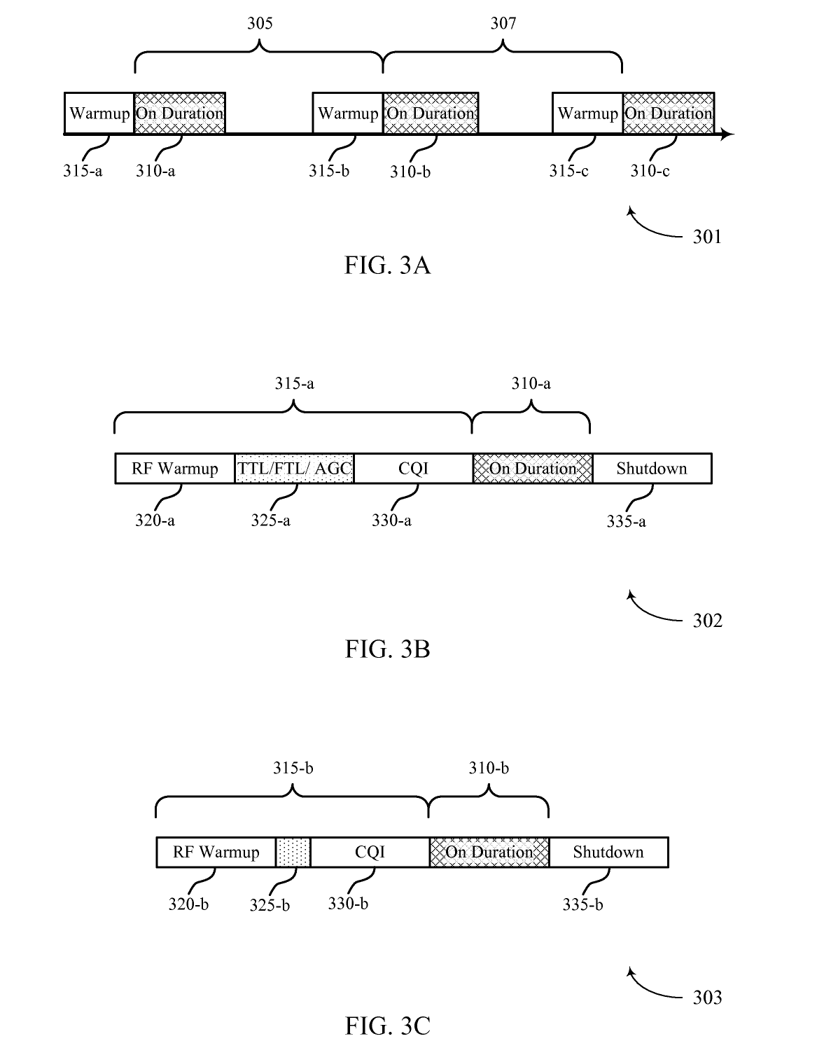

FIG. 3A shows a diagram 301 of an example DRX operation that may be configured for a UE 115 in accordance with various aspects of the present disclosure. As illustrated in diagram 301, a UE 115 may be configured with a first DRX cycle 305 and a second DRX cycle 307, which include On Durations 310 separated by DRX periods. During On Durations 310, the UE 115 may be expected to be able to receive communications from the base station 105. Diagram 301 shows On Durations 310-a, 310-b and 310-c configured according to DRX cycle 305, where each configured On Duration may be followed by a low power period (e.g., DRX Opportunity, etc.) during which various radio components (e.g., RF components, baseband components, etc.) may be de-activated. In order to be ready for possible communications in On Durations 310, the On Durations 310 may each be preceded by a warmup period 315, during which the UE 115 activates one or more radio components and estimates channel parameters in preparation to send and receive data over a wireless link 125 (not shown). The warmup periods 315 may be dynamically adjusted based on an estimate of the variance of channel conditions from the previous On Duration 310. For example, warmup period 315-b may be updated (e.g., adjusted to be a longer period or a shorter period than warmup period 315-a) based on an estimate of the difference in channel conditions between On Duration 310-a and On Duration 310-b.

FIG. 3B shows a diagram 302 of an example DRX operation that includes dynamically adjusting the warmup period in accordance with various aspects of the present disclosure. On Duration 310-a may be preceded by a warmup period 315-a, during which the UE 115 activates one or more radio components and estimates channel parameters in preparation to send and receive data over a wireless link 125 (not shown). Warmup period 315-a may include radio frequency (RF) warmup period 320-a in which components of the radio that operate at RF frequencies are activated. Additionally or alternatively, warmup period 315-a may include baseband convergence period 325-a, during which baseband components are activated and channel parameters are estimated. Additionally or alternatively, warmup period 315-a may include a channel quality indicator (CQI) report period 330-a, during which the UE 115 may perform measurement and processing for generating a CQI report. For example, the UE 115 may generate a CQI report during a warmup period 315-a if a CQI report is to be transmitted during the initial portion of an On Duration 310-a. Baseband convergence period 325-a may include at least one of a time period for automatic gain control, a time period for frequency tracking loop convergence, or a time period for time tracking loop convergence. A UE 115 may adjust the baseband convergence period 325-a based on an estimate of the channel variance since the previous On Duration (not shown). The total warmup period 315-a may be adjusted accordingly to determine the time at which the RF warmup period 320-a should begin to ensure the RF and baseband components are ready to receive transmission from the base station at the start of the On Duration 310-a.

After warmup period 315-a, the UE 115 may be ready to send and receive data during On Duration 310-a. Thus, the time at which the UE 115 initiates the warmup period 315-a may be based on a time at which the UE is scheduled for On Duration 310-a, and also on factors such as the length of the baseband convergence period 325-a, and whether the UE 115 is to generate a CQI report or when the CQI report is to be sent relative to the start of the On Duration. In some examples the warmup time may, additionally or alternatively, be based on a duplexing configuration of the wireless channel such as a frequency division duplex (FDD) configuration or a time division duplex (TDD) configuration. On Duration 310-a may be followed by a shutdown period 335-a during which one or more radio components are deactivated in preparation for entering a DRX sleep mode.

FIG. 3C shows a diagram 303 of an example DRX operation that includes dynamically adjusting the warmup period in accordance with various aspects of the present disclosure. DRX process 303 may illustrate an On Duration 310-b for which the warmup period 315-b is shorter than the warmup period 315-a of On Duration 310-a described with reference to FIG. 3B. A UE 115 may reduce the length of the warmup period 315-b by reducing the baseband convergence period 325-b (in relation to baseband convergence period 325-a). For example, a UE 115 may reduce the baseband convergence period 325-b based on an estimate that channel conditions have not changed substantially since the previous On Duration 310-a. If the channel conditions have not substantially changed, a shorter time period may be sufficient for automatic gain control, frequency tracking loop convergence, and/or time tracking loop convergence.

Warmup period 315-b may also include RF warmup period 320-b, which may be the same as RF warmup period 320-a. CQI report period 330-b may be the same as CQI report period 330-a, or it may be excluded if the UE 115 is not scheduled to transmit a CQI report during On Duration 310-b. On Duration 310-b may also be followed by a shutdown period 335-b, which may be the same as shutdown period 335-a. Thus, a UE 115 may conserve energy by reducing the total warmup period 315-b during which one or more radio components are activated, while still allowing enough time for baseband convergence and acceptable channel parameter estimates during baseband convergence period 325-b, and maintaining the same On Duration 310-b.

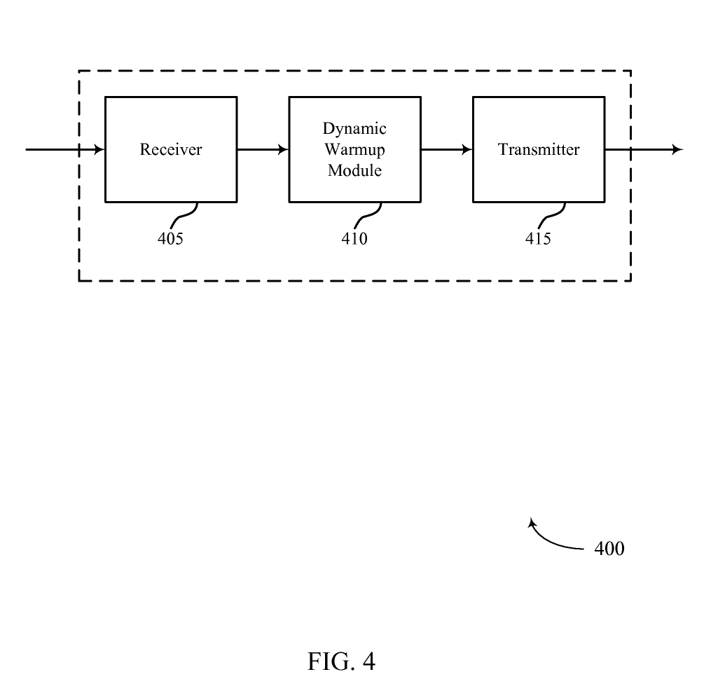

FIG. 4 shows a block diagram of a device 400 for improving DRX power usage by dynamically adjusting a warmup period in accordance with various aspects of the present disclosure. The device 400 may be an example of one or more aspects of UEs 115 described with reference to FIGS. 1-3. The device 400 may include a receiver 405, a dynamic warmup module 410, and/or a transmitter 415. In aspects, the device 400 may also include a processor. Each of these components may be in communication with each other.

The components of the device 400 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another Semi-Custom IC), which may be programmed in any manner known in the art. The functions of each unit may also be implemented, in whole or in part, with instructions embodied in a memory, formatted to be executed by one or more general or application-specific processors.

The receiver 405 may receive information such as packets, user data, and/or control information associated with various information channels (e.g., control channels, data channels, etc.). Information may be passed on to the dynamic warmup module 410, and to other components of the device 400. In some cases, components of the receiver 405 may be turned on and off according to a DRX cycle.

The dynamic warmup module 410 may be configured to communicate over a wireless channel in a DRX mode for a time period comprising a first on duration of a first DRX cycle and a second on duration of a second DRX cycle. The dynamic warmup module 410 may be configured to estimate a channel variance for the wireless channel based on a set of parameters comprising at least one parameter measured during the first DRX cycle. The dynamic warmup module 410 may be configured to update a baseband convergence period for the second on duration of the second DRX cycle based on the estimated channel variance.

The transmitter 415 may transmit the one or more signals received from other components of the device 400. In some embodiments, the transmitter 415 may be collocated with the receiver 405 in a transceiver module. The transmitter 415 may include a single antenna, or it may include a plurality of antennas. In some cases, components of the transmitter 415 may be turned on and off according to a DRX cycle.

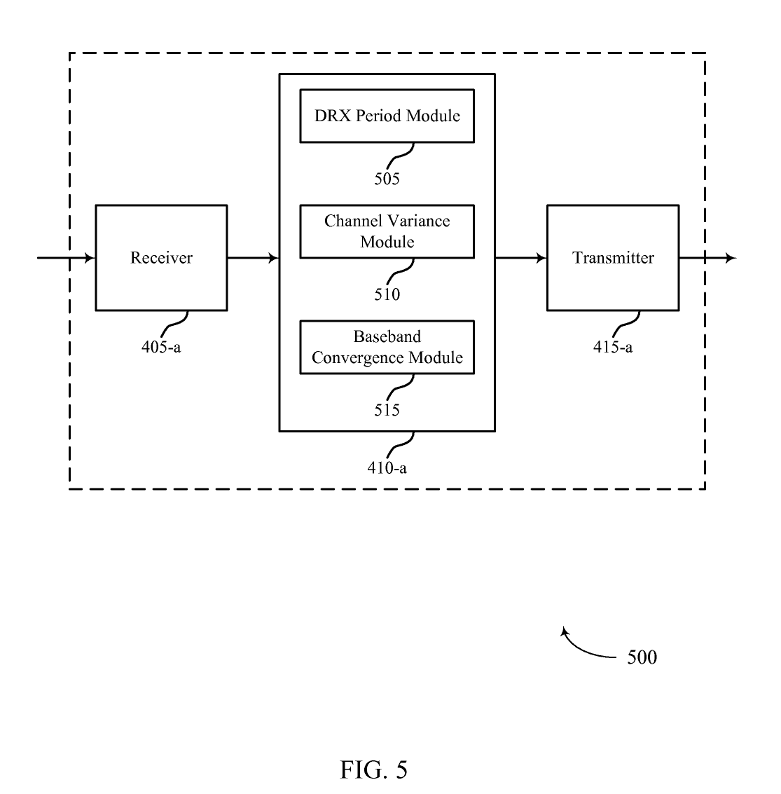

FIG. 5 shows a block diagram of a device 500 for improving DRX power usage by dynamically adjusting a warmup period in accordance with various aspects of the present disclosure. The device 500 may be an example of one or more aspects of UEs 115 described with reference to FIGS. 1-4. The device 500 may include a receiver 405-a, a dynamic warmup module 410-a, and/or a transmitter 415-a. In aspects, the device 500 may also include a processor. Each of these components may be in communication with each other. The dynamic warmup module 410-a may also include a DRX period module 505, a channel variance module 510, and a baseband convergence module 515.

The components of the device 500 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The receiver 405-a may receive information which may be passed on to the dynamic warmup module 410-a, and to other components of the device 500. The dynamic warmup module 410-a may be configured to perform the operations described above with reference to FIG. 4. The transmitter 415-a may transmit the one or more signals received from other components of the device 500. In some cases, components of the receiver 405-a and transmitter 415-a may be turned on and off according to a DRX cycle.

The DRX period module 505 may be configured to determine a number of subframes for DRX On Duration and a DRX sleep period. The DRX configuration may be based on a schedule received from a base station 105. Thus, the DRX period module 505 may be configure to cause device 500 to communicate over a wireless channel in a DRX mode for a time period comprising a first on duration of a first DRX cycle and a second on duration of a second DRX cycle, during which a portion of the time period is spent in a DRX sleep state.

The channel variance module 510 may be configured to estimate a channel variance for the wireless channel (e.g., between the On Duration of a first DRX cycle and the On Duration of a second DRX cycle). Channel variance may be estimated based on a set of parameters including at least one parameter measured during the first DRX cycle. The set of parameters may include a Doppler measurement, an acceleration measurement, a channel correlation measurement, channel SNR, DRX cycle period, and/or DRX gap length. The estimate of channel variance may depend on other parameters such as cell class (e.g., macro, pico, femto, etc.), cell size, and/or local topology. In still other examples, the set of parameters may include operational parameters for the device 500 including transmission mode, rank, and/or channel quality (e.g., based on a CQI report generated in the first DRX cycle or based on modulation and coding scheme (MCS) index for transport blocks received during the first DRX cycle, etc.).

In some examples, a compound channel variance estimate may be based on a function of the parameters described above. For example, a Doppler measurement may be an indication of the velocity of the device 500, and combined with a DRX gap length, may be an indication of how far the device 500 has moved within the coverage area 110 of a base station 105. If the device 500 has moved a relatively long distance, it may be more likely that channel conditions have changed. Similarly, if the device 500 is experiencing high acceleration, the device 500 may estimate that channel conditions are likely to have changed significantly. In some cases, an estimate of channel variance may be obtained by multiplying a velocity estimate (e.g., from a Doppler measurement) by the DRX gap length (e.g., using a suitable factor, etc.).

In another example, an estimate of a channel variance may be based on a change in a position parameter such as a position measured by a global positioning system (GPS), radio triangulation, or inertial sensor on the device 500. For example, acceleration measurements during the DRX gap may be used to determine if velocity has changed between On Durations.

In yet other examples, the compound channel variance estimate may be calculated based on a function of channel correlation and UE velocity. For example, for environments with high channel correlation, channel variance (e.g., based on UE speed, etc.) may be adjusted down while in multipath environments channel variance may be increased by a suitable factor. In some cases, the channel variance may be associated with a channel model such as an additive white Gaussian noise (AWGN), or a multipath fading propagation model such as an extended pedestrian A(EPA) model, an extended vehicular A (EVA) model, or an extended typical urban (ETU) model.

The baseband convergence module 515 may be configured to update a baseband convergence period for the warmup period 315-b preceding second on duration 310-b of the second DRX cycle based on the estimated channel variance. In some examples, the baseband convergence period includes at least one of a time period for automatic gain control, a time period for frequency tracking loop convergence, or a time period for time tracking loop convergence. In some examples, updating the baseband convergence period includes reducing the baseband convergence period based on a function relating the estimated channel variance to a time for a baseband convergence period. In some examples, updating the baseband convergence period includes increasing the baseband convergence period based on a function relating the estimated channel variance to a time for a baseband convergence period. In some examples, updating the baseband convergence period may be based on a lookup of the estimated channel variance in a table relating a set of channel variance values with a set of baseband convergence periods.

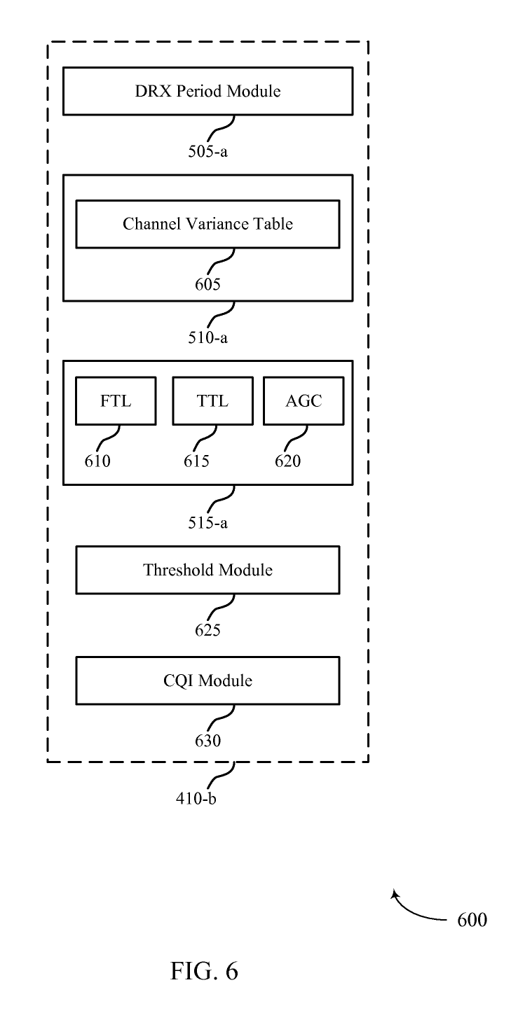

FIG. 6 shows a block diagram 600 of a dynamic warmup module 410-b for improving DRX power usage by dynamically adjusting a warmup period in accordance with various aspects of the present disclosure. The dynamic warmup module 410-b may be an example of one or more aspects of a dynamic warmup module 410 described with reference to FIGS. 4-5. The dynamic warmup module 410-b may include a DRX period module 505-a, a channel variance module 510-a, and a baseband convergence module 515-a. Each of these modules may perform the functions of the corresponding modules described above with reference to FIG. 5. The channel variance module 510-a may also include a channel variance table 605. The baseband convergence module 515-a may also include a frequency tracking loop module (FTL) 610, a time tracking loop (TTL) module 615, and an automatic gain control (AGC) module 620. The dynamic warmup module 410-b may include a threshold module 625 and/or a CQI module 630.

The components of the dynamic warmup module 410-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The channel variance table 605 may be configured to maintain a table relating a set of channel variance values with a set of baseband convergence periods. For example, the channel variance table 605 may associate estimates of relatively large channel variance with higher baseband convergence periods and estimates of relatively small channel variance with lower baseband convergence periods.

FTL module 610 may perform frequency estimation during a baseband convergence period. TTL module 615 may perform time synchronization during a baseband convergence period. AGC module 620 may perform automatic gain control during a baseband convergence period.

Threshold module 625 may be configured to determine whether an estimated channel variance satisfies a channel variance threshold. For example, if the estimated channel variance is high, the threshold may be satisfied and a relatively long baseband convergence period may be selected. If the estimated channel variance is low, the threshold may not be satisfied and a relatively short baseband convergence period may be selected. In some cases, the range of estimated channel variance values may be divided into a plurality of sub-ranges, and each sub-range may be associated with a baseband convergence period. Thus, determining whether an estimated channel variance satisfies a threshold may include determining whether the estimated channel variance falls within a sub-range.

The CQI module 630 may be configured to generate a CQI report based on channel estimates. The CQI module 630 may be configured to coordinate with the dynamic warmup module 410 to adjust the warmup time based on a time period for generating a CQI report. Generating a CQI report may not be necessary for every DRX cycle.

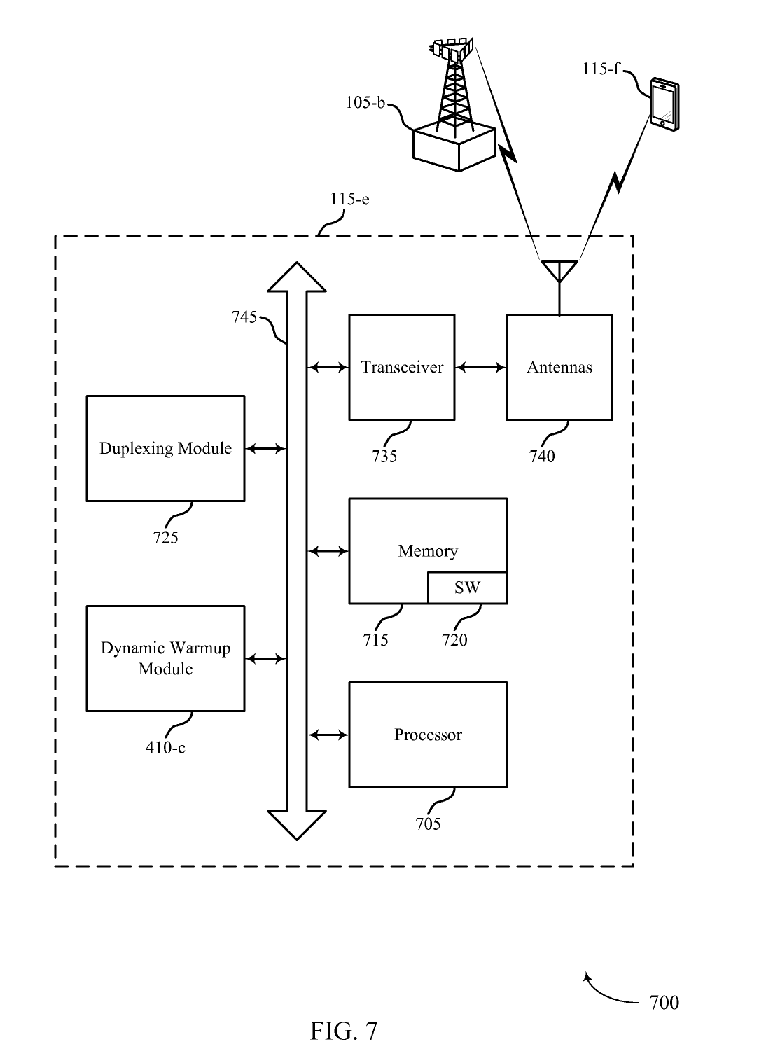

FIG. 7 shows a diagram of a system 700 for improving DRX power usage by dynamically adjusting a warmup period in accordance with various aspects of the present disclosure. System 700 may include a UE 115-e, which may be an example of an UE 115 described with reference to FIGS. 1-6. The UE 115-e may include a dynamic warmup module 410-c, which may be an example of dynamic warmup modules 410 described with reference to FIGS. 4-6. The UE 115-e may also include a duplexing module 725. The UE 115-e may include components for bi-directional voice and data communications including components for transmitting communications and components for receiving communications. For example, UE 115-e may communicate with base station 105-b and/or UE 115-f.

The duplexing module 725 may be configured to support duplexing operation of the UE 115-e. For example, the duplexing module 725 may be configured according to an FDD configuration or a TDD configuration. The UE 115-e may also be configured for full duplex of half-duplex operation. In some cases, the duplexing module 725 may be configured such that the warmup time may be further based on the duplexing configuration. For example, a number of subframes for baseband convergence may be determined, and the warmup period may be adjusted to account for subframes prior to the On Duration that are not used for baseband convergence (e.g., uplink subframes for TDD, etc.)

The UE 115-e may include a processor module 705, and memory 715 (e.g., including software (SW) 720), a transceiver module 735, and one or more antenna(s) 740, which each may communicate, directly or indirectly, with each other (e.g., via one or more buses 745. The transceiver module 735 may be configured to communicate bi-directionally, via the antenna(s) 740 and/or one or more wired or wireless links, with one or more networks, as described above. For example, the transceiver module 735 may be configured to communicate bi-directionally with a base station 105. The transceiver module 735 may include a modem configured to modulate the packets and provide the modulated packets to the antenna(s) 740 for transmission, and to demodulate packets received from the antenna(s) 740. While the UE 115-e may include a single antenna 740, in aspects, the UE 115-e may have multiple antennas 740 capable of concurrently transmitting and/or receiving multiple wireless transmissions. The transceiver module 735 may also be capable of concurrently communicating with one or more base stations 105.

The memory 715 may include random access memory (RAM) and read only memory (ROM). The memory 715 may store computer-readable, computer-executable software/firmware code 720 including instructions that are configured to, when executed, cause the processor module 705 to perform various functions described herein (e.g., communicate in DRX mode, estimate channel variance, adjust a DRX warmup period, etc.). Alternatively, the software/firmware code 720 may not be directly executable by the processor module 705 but be configured to cause a computer (e.g., when compiled and executed) to perform functions described herein. The processor module 705 may include an intelligent hardware device, e.g., a central processing unit (CPU), a microcontroller, an ASIC, etc. may include embedded memory (e.g., cache, etc.).

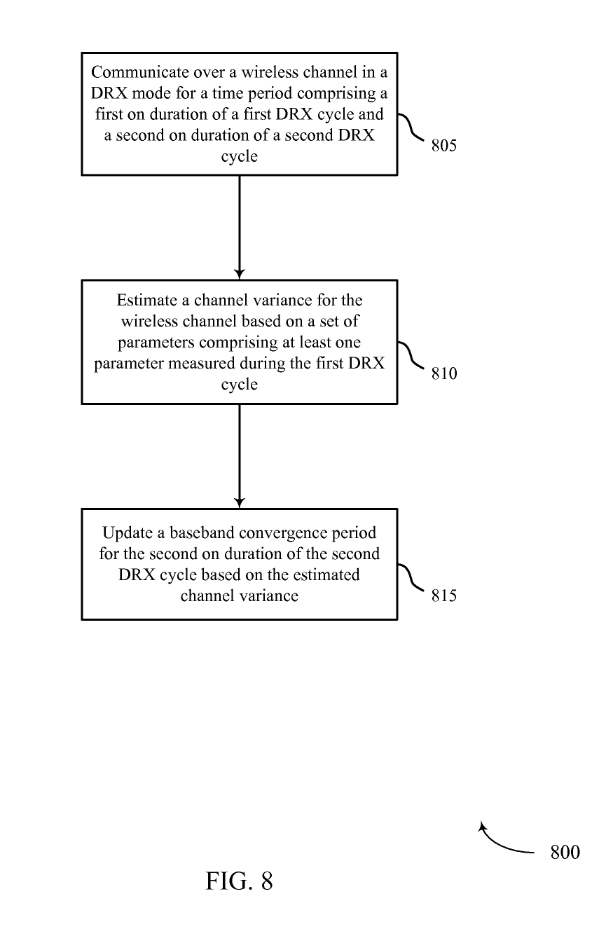

FIG. 8 shows a flowchart 800 illustrating a method for improving DRX power usage by dynamically adjusting a warmup period in accordance with various aspects of the present disclosure. The functions of flowchart 800 may be implemented by a UE 115 or one or more of its components such as devices 400 or 500 as described with reference to FIGS. 1-7. In certain examples, one or more of the blocks of the flowchart 800 may be performed by the dynamic warmup module 410 as described with reference to FIGS. 4-7.

At block 805, the UE 115 may communicate over a wireless channel in a DRX mode for a time period comprising a first on duration of a first DRX cycle 305 and a second on duration of a second DRX cycle 307. In certain examples, the functions of block 805 may be performed by the DRX period module 505 as described above with reference to FIG. 5.

At block 810, the UE 115 may estimate a channel variance for the wireless channel based on a set of parameters comprising at least one parameter measured during the first DRX cycle. In certain examples, the functions of block 810 may be performed by the channel variance module 510 as described above with reference to FIG. 5.

At block 815, the UE 115 may update a baseband convergence period for the second on duration of the second DRX cycle based on the estimated channel variance. In certain examples, the functions of block 815 may be performed by the baseband convergence module 515 as described above with reference to FIG. 5.

It should be noted that the method of flowchart 800 is just one implementation and that the operations of the method, and the steps may be rearranged or otherwise modified such that other implementations are possible.

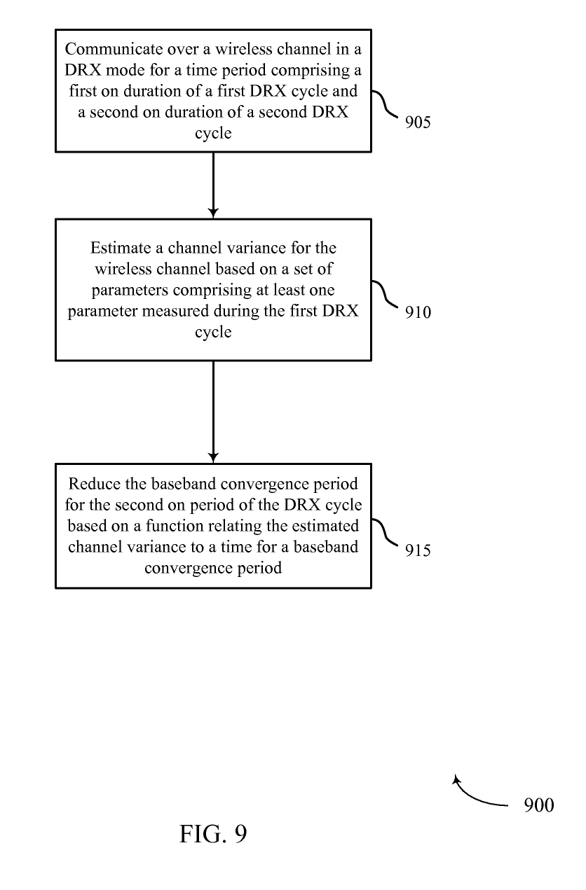

FIG. 9 shows a flowchart 900 illustrating a method for improving DRX power usage by dynamically adjusting a warmup period in accordance with various aspects of the present disclosure. The functions of flowchart 900 may be implemented by a UE 115 or one or more of its components such as devices 400 or 500 as described with reference to FIGS. 1-7. In certain examples, one or more of the blocks of the flowchart 900 may be performed by the dynamic warmup module 410 as described with reference to FIGS. 4-7. The method described in flowchart 900 may also incorporate aspects of flowchart 800 of FIG. 8.

At block 905, the UE 115 may communicate over a wireless channel in a DRX mode for a time period including a first On Duration of a first DRX cycle and a second On Duration of a second DRX cycle. In certain examples, the functions of block 905 may be performed by the DRX period module 505 as described above with reference to FIG. 5.

At block 910, the UE 115 may estimate a channel variance for the wireless channel based on a set of parameters comprising at least one parameter measured during the first DRX cycle. In certain examples, the functions of block 910 may be performed by the channel variance module 510 as described above with reference to FIG. 5 and possibly in conjunction with the threshold module 625 as described above with reference to FIG. 6.

At block 915, the UE 115 may reduce the baseband convergence period for the second on period of the DRX cycle based on the estimated channel variance based on a function relating the estimated channel variance to a time for a baseband convergence period. In certain examples, the functions of block 915 may be performed by the baseband convergence module 515 as described above with reference to FIG. 5 and possibly in conjunction with the threshold module 625 as described above with reference to FIG. 6.

It should be noted that the method of flowchart 900 is just one implementation and that the operations of the method, and the steps may be rearranged or otherwise modified such that other implementations are possible.

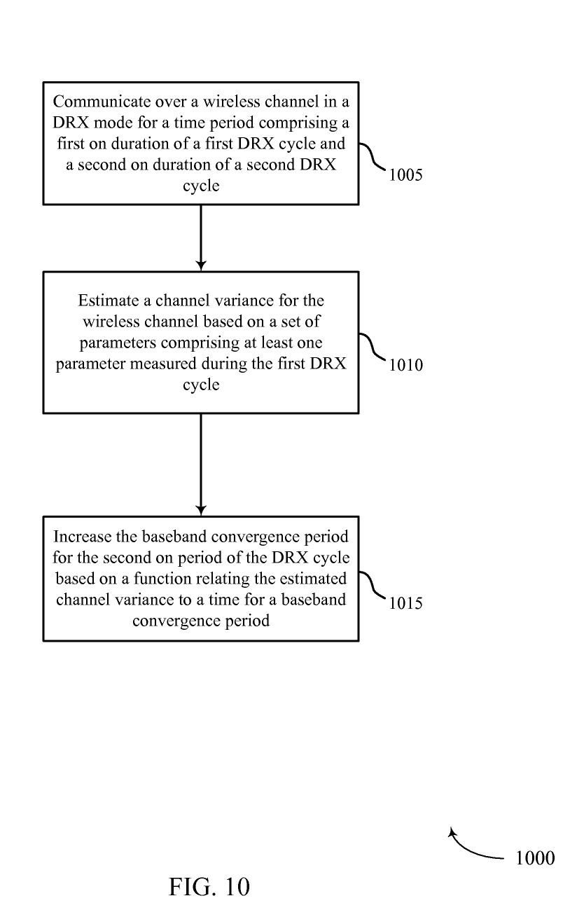

FIG. 10 shows a flowchart 1000 illustrating a method for improving DRX power usage by dynamically adjusting a warmup period in accordance with various aspects of the present disclosure. The functions of flowchart 1000 may be implemented by a UE 115 or one or more of its components such as devices 400 or 500 as described with reference to FIGS. 1-7. In certain examples, one or more of the blocks of the flowchart 1000 may be performed by the dynamic warmup module 410 as described with reference to FIGS. 4-7. The method described in flowchart 1000 may also incorporate aspects of flowchart 800 of FIG. 8.

At block 1005, the UE 115 may communicate over a wireless channel in a DRX mode for a time period including a first on duration of a first DRX cycle and a second on duration of a second DRX cycle. In certain examples, the functions of block 1005 may be performed by the DRX period module 505 as described above with reference to FIG. 5.

At block 1010, the UE 115 may estimate a channel variance for the wireless channel based on a set of parameters including at least one parameter measured during the first DRX cycle. In certain examples, the functions of block 1010 may be performed by the channel variance module 510 as described above with reference to FIG. 5 and possibly in conjunction with the threshold module 625 as described above with reference to FIG. 6.

At block 1015, the UE 115 may increase the baseband convergence period for the second on period of the DRX cycle based on the estimated channel variance based on a function relating the estimated channel variance to a time for a baseband convergence period. In certain examples, the functions of block 1015 may be performed by the baseband convergence module 515 as described above with reference to FIG. 5 and possibly in conjunction with the threshold module 625 as described above with reference to FIG. 6.

It should be noted that the method of flowchart 1000 is just one implementation and that the operations of the method, and the steps may be rearranged or otherwise modified such that other implementations are possible.

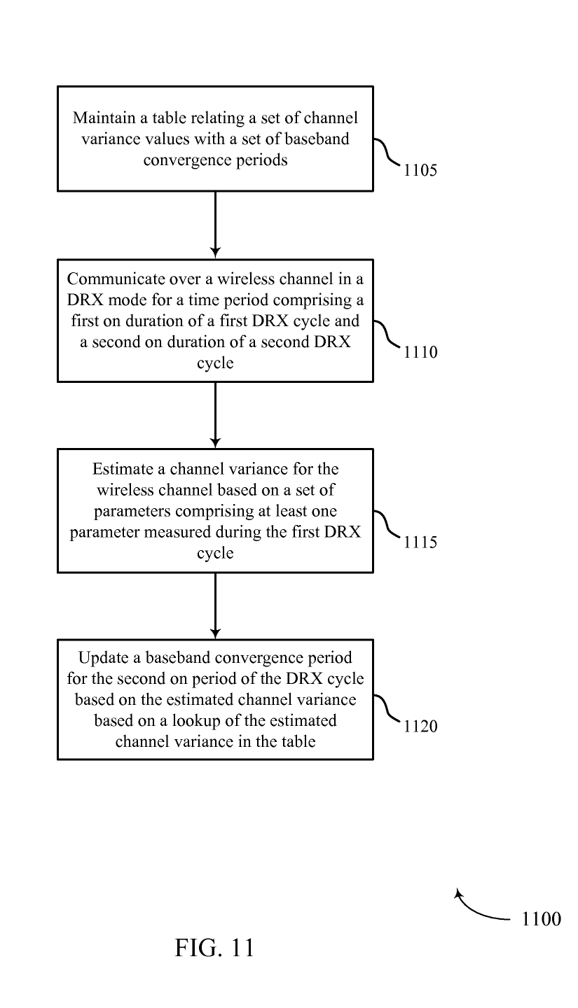

FIG. 11 shows a flowchart 1100 illustrating a method for improving DRX power usage by dynamically adjusting a warmup period in accordance with various aspects of the present disclosure. The functions of flowchart 1100 may be implemented by a UE 115 or one or more of its components such as devices 400 or 500 as described with reference to FIGS. 1-7. In certain examples, one or more of the blocks of the flowchart 1100 may be performed by the dynamic warmup module 410 as described with reference to FIGS. 4-7. The method described in flowchart 1100 may also incorporate aspects of flowcharts 800, 900, or 1000 of FIGS. 8-10.

At block 1105, the UE 115 may maintain a table relating a set of channel variance values with a set of baseband convergence periods. In certain examples, the functions of block 1105 may be performed by the channel variance table 605 as described above with reference to FIG. 6.

At block 1110, the UE 115 may communicate over a wireless channel in a DRX mode for a time period comprising a first on duration of a first DRX cycle and a second on duration of a second DRX cycle. In certain examples, the functions of block 1110 may be performed by the DRX period module 505 as described above with reference to FIG. 5.

At block 1115, the UE 115 may estimate a channel variance for the wireless channel based on a set of parameters comprising at least one parameter measured during the first DRX cycle. In certain examples, the functions of block 1115 may be performed by the channel variance module 510 as described above with reference to FIG. 5 and possibly in conjunction with the threshold module 625 as described above with reference to FIG. 6.

At block 1120, the UE 115 may update a baseband convergence period for the second on period of the DRX cycle based on the estimated channel variance based on a lookup of the estimated channel variance in the table relating a set of channel variance values with a set of baseband convergence periods. In certain examples, the functions of block 1120 may be performed by the baseband convergence module 515 as described above with reference to FIG. 5 in conjunction with the channel variance table 605 and possibly in conjunction with the threshold module 625 as described above with reference to FIG. 6 as described above with reference to FIG. 6.

It should be noted that the method of flowchart 1100 is just one implementation and that the operations of the method, and the steps may be rearranged or otherwise modified such that other implementations are possible.

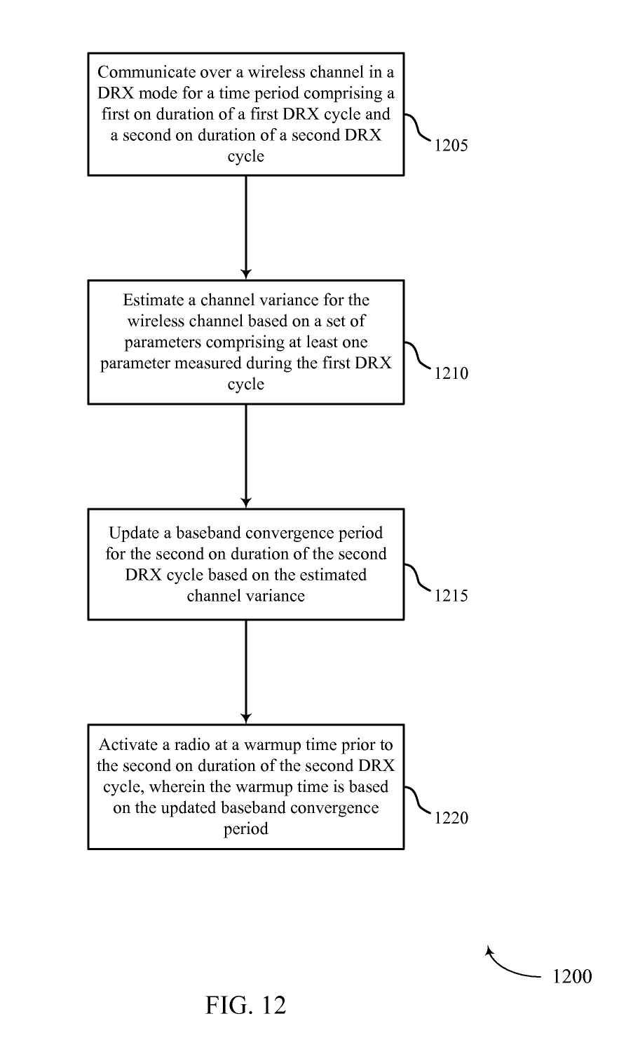

FIG. 12 shows a flowchart 1200 illustrating a method for improving DRX power usage by dynamically adjusting a warmup period in accordance with various aspects of the present disclosure. The functions of flowchart 1200 may be implemented by a UE 115 or one or more of its components such as devices 400 or 500 as described with reference to FIGS. 1-7. In certain examples, one or more of the blocks of the flowchart 1200 may be performed by the dynamic warmup module as described with reference to FIGS. 4-7. The method described in flowchart 1200 may also incorporate aspects of flowcharts 800, 900, 1000, or 1100 of FIGS. 8-11.

At block 1205, the UE 115 may communicate over a wireless channel in a DRX mode for a time period comprising a first on duration of a first DRX cycle and a second on duration of a second DRX cycle. In certain examples, the functions of block 1205 may be performed by the DRX period module 505 as described above with reference to FIG. 5.

At block 1210, the UE 115 may estimate a channel variance for the wireless channel based on a set of parameters comprising at least one parameter measured during the first DRX cycle. In certain examples, the functions of block 1210 may be performed by the channel variance module 510 as described above with reference to FIG. 5 and possibly in conjunction with the threshold module 625 as described above with reference to FIG. 6.

At block 1215, the UE 115 may update a baseband convergence period for the second on duration of the second DRX cycle based on the estimated channel variance. In certain examples, the functions of block 1215 may be performed by the baseband convergence module 515 as described above with reference to FIG. 5 and possibly in conjunction with the threshold module 625 as described above with reference to FIG. 6.

At block 1220, the UE 115 may activate a radio at a warmup time prior to the second on duration of the second DRX cycle, wherein the warmup time is based on the updated baseband convergence period. In certain examples, the functions of block 1220 may be performed by the dynamic warmup module 615 described above with reference to FIG. 6.

It should be noted that the method of flowchart 1200 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can include RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
communicating over a wireless channel in a discontinuous reception (DRX) mode for a time period comprising a first on duration of a first DRX cycle and a second on duration of a second DRX cycle;
estimating a channel variance for the wireless channel based on a set of parameters comprising at least one parameter measured during the first DRX cycle; and
updating a baseband convergence period for the second on duration of the second DRX cycle based on the estimated channel variance.

2. The method of claim 1, wherein the set of parameters comprises at least one of a Doppler measurement, an acceleration measurement, a channel correlation measurement, a signal-to-noise ratio (SNR), or a DRX gap length.

3. The method of claim 1, wherein the baseband convergence period comprises at least one of a time period for automatic gain control, a time period for frequency tracking loop convergence, or a time period for time tracking loop convergence.

4. The method of claim 1, further comprising:
updating the baseband convergence period comprises reducing the baseband convergence period based on a function relating the estimated channel variance to a time for a baseband convergence period based on a function relating the estimated channel variance to a time for a baseband convergence period.

5. The method of claim 1, further comprising:
updating the baseband convergence period comprises increasing the baseband convergence period based on a function relating the estimated channel variance to a time for a baseband convergence period based on a function relating the estimated channel variance to a time for a baseband convergence period.

6. The method of claim 1, further comprising:
maintaining a table relating a set of channel variance values with a set of baseband convergence periods; and
wherein updating the baseband convergence period comprises updating the baseband convergence period based on a lookup of the estimated channel variance in the table.

7. The method of claim 1, further comprising:
activating a radio at a warmup time prior to the second on duration of the second DRX cycle, wherein the warmup time is based on the updated baseband convergence period.

8. The method of claim 7, wherein the warmup time is further based on a time period for generating a channel quality indicator (CQI) report.

9. The method of claim 7, wherein the warmup time is further based on a duplexing configuration of the wireless channel, the duplexing configuration comprising a frequency division duplex (FDD) configuration or a time division duplex (TDD) configuration.

10. An apparatus for wireless communication at a user equipment (UE), comprising:
means for communicating over a wireless channel in a discontinuous reception (DRX) mode for a time period comprising a first on duration of a first DRX cycle and a second on duration of a second DRX cycle;
means for estimating a channel variance for the wireless channel based on a set of parameters comprising at least one parameter measured during the first DRX cycle; and
means for updating a baseband convergence period for the second on duration of the second DRX cycle based on the estimated channel variance.

11. The apparatus of claim 10, wherein the set of parameters comprises at least one of a Doppler measurement, an acceleration measurement, a channel correlation measurement, a signal-to-noise ratio (SNR), or a DRX gap length.

12. The apparatus of claim 10, wherein the baseband convergence period comprises at least one of a time period for automatic gain control, a time period for frequency tracking loop convergence, or a time period for time tracking loop convergence.

13. The apparatus of claim 10, further comprising:
means for reducing the baseband convergence period based on a function relating the estimated channel variance to a time for a baseband convergence period.

14. The apparatus of claim 10, further comprising:
means for increasing the baseband convergence period based on a function relating the estimated channel variance to a time for a baseband convergence period.

15. The apparatus of claim 10, further comprising:
means for maintaining a table relating a set of channel variance values with a set of baseband convergence periods; and
means for updating the baseband convergence period based on a lookup of the estimated channel variance in the table.

16. The apparatus of claim 10, further comprising:
means for activating a radio at a warmup time prior to the second on duration of the second DRX cycle, wherein the warmup time is based on the updated baseband convergence period.

17. The apparatus of claim 16, wherein the warmup time is further based on a time period for generating a channel quality indicator (CQI) report.

18. The apparatus of claim 16, wherein the warmup time is further based on a duplexing configuration of the wireless channel, the duplexing configuration comprising a frequency division duplex (FDD) configuration or a time division duplex (TDD) configuration.

19. An apparatus for wireless communication at a user equipment (UE), comprising a processor, memory in electronic communication with the processor and instructions stored in the memory, the instructions being executable by the processor to:
communicate over a wireless channel in a discontinuous reception (DRX) mode for a time period comprising a first on duration of a first DRX cycle and a second on duration of a second DRX cycle;
estimate a channel variance for the wireless channel based on a set of parameters comprising at least one parameter measured during the first DRX cycle; and
update a baseband convergence period for the second on duration of the second DRX cycle based on the estimated channel variance.

20. The apparatus of claim 19, wherein the set of parameters comprises at least one of a Doppler measurement, an acceleration measurement, a channel correlation measurement, a signal-to-noise ratio (SNR), or a DRX gap length.

21. The apparatus of claim 19, wherein the baseband convergence period comprises at least one of a time period for automatic gain control, a time period for frequency tracking loop convergence, or a time period for time tracking loop convergence.

22. The apparatus of claim 19, wherein the instructions are further executable by the processor to:
reduce the baseband convergence period based on a function relating the estimated channel variance to a time for a baseband convergence period.

23. The apparatus of claim 19, wherein the instructions are further executable by the processor to:
increase the baseband convergence period based on a function relating the estimated channel variance to a time for a baseband convergence period.

24. The apparatus of claim 19, wherein the instructions are further executable by the processor to:
maintain a table relating a set of channel variance values with a set of baseband convergence periods; and
update the baseband convergence period based on a lookup of the estimated channel variance in the table.

25. The apparatus of claim 19, wherein the instructions are further executable by the processor to:
activate a radio at a warmup time prior to the second on duration of the second DRX cycle, wherein the warmup time is based on the updated baseband convergence period.

26. The apparatus of claim 25, wherein the warmup time is further based on a time period for generating a channel quality indicator (CQI) report.

27. The apparatus of claim 25, wherein the warmup time is further based on a duplexing configuration of the wireless channel, the duplexing configuration comprising a frequency division duplex (FDD) configuration or a time division duplex (TDD) configuration.

28. A non-transitory computer-readable medium storing code for wireless communication at a user equipment (UE), the code comprising instructions executable by a processor to:
communicate over a wireless channel in a discontinuous reception (DRX) mode for a time period comprising a first on duration of a first DRX cycle and a second on duration of a second DRX cycle;
estimate a channel variance for the wireless channel based on a set of parameters comprising at least one parameter measured during the first DRX cycle; and
update a baseband convergence period for the second on duration of the second DRX cycle based on the estimated channel variance.

29. The non-transitory computer-readable medium of claim 28, wherein the set of parameters comprises at least one of a Doppler measurement, an acceleration measurement, a channel correlation measurement, a signal-to-noise ratio (SNR), or a DRX gap length.

30. The non-transitory computer-readable medium of claim 28, wherein the baseband convergence period comprises at least one of a time period for automatic gain control, a time period for frequency tracking loop convergence, or a time period for time tracking loop convergence.
